(19) United States
(12) Patent Application Publication
(10) Pub. No.: US 2024/0212183 A1
(43) Pub. Date: Jun. 27, 2024

(54) INFORMATION PROCESSING APPARATUS THAT PROCESSES 3D INFORMATION, INFORMATION PROCESSING METHOD, AND INFORMATION PROCESSING SYSTEM

(71) Applicant: CANON KABUSHIKI KAISHA, Tokyo (JP)

(72) Inventor: Ryotaro TAKAHASHI, Tokyo (JP)

(21) Appl. No.: 18/394,001

(22) Filed: Dec. 22, 2023

(30) Foreign Application Priority Data
Dec. 26, 2022 (JP) 2022-208800

(51) Int. Cl. G06T 7/521; G01B 11/24; G06T 3/40; H04N 23/69

(52) U.S. Cl. CPC G06T 7/521; G01B 11/24; G06T 3/40; H04N 23/69; G06T 2207/10028; G06T 2207/20212; G06V 10/25

(57) ABSTRACT

An information processing apparatus for processing three-dimensional (3D) information is disclosed. The apparatus obtains 3D shape data representing a shape of a 3D object and data of an image of a field of view including the 3D object. The apparatus generates a depth map corresponding to the field of view based on the 3D shape data and increases a resolution of an area of the depth map corresponding to an area of interest set for the image. The apparatus generates 3D shape data based on the depth map with a resolution of an area corresponding to the area of interest increased.

### BACKGROUND OF THE INVENTION

### Field of the Invention

The present invention relates to an information processing apparatus that processes three-dimensional (3D) information, an information processing method, and an information processing system.

### Description of the Related Art

Shape data (3D shape data) of a 3D object has become widely used in recent times. When expressing the shape of a 3D object using point group data, i.e., a set of 3D coordinate data, the higher the density of the 3D coordinates is, the higher the accuracy of the shape is.

However, when the density of the 3D coordinates is high, the processing load when generating and using the 3D shape data is increased. The volume of the 3D shape data is also increased. Apparatuses (such a light detection and ranging (LiDAR) sensors) that measure 3D shapes with high accuracy are typically large in size and high in cost.

As a method for reducing the amount of calculations required to obtain 3D shape data, Japanese Patent Laid-Open No. 2012-13660 proposes a method in which the shape of a 3D object is understood as a set of planes and the contour lines are deduced to exist at the boundary between planes.

In the method proposed in Japanese Patent Laid-Open No. 2012-13660, to increase the accuracy of the 3D shape data, the contour lines need to be deduced with greater accuracy. Then, to deduce the contour lines with greater accuracy, the detection accuracy of the planes needs to be increased. As a result, 3D object point group data for detecting planes needs to be obtained overall with high density, and the problems such as an increase in the processing load required for point group data generation and an increase in the size and cost of the measurement apparatus cannot be resolved.

### SUMMARY OF THE INVENTION

In consideration of the aforementioned problems with known techniques, an aspect of the present invention provides an information processing apparatus and an information processing method that can generate 3D shape data efficiently and with good accuracy.

According to an aspect of the present invention, there is provided an information processing apparatus for processing three-dimensional (3D) information, comprising: one or more processors that execute a program stored in a memory and thereby function as: a first obtaining unit configured to obtain 3D shape data representing a shape of a 3D object, a second obtaining unit configured to obtain data of an image of a field of view including the 3D object, a converting unit configured to generate a depth map corresponding to the field of view based on the 3D shape data, a resolution converting unit configured to increase a resolution of an area of the depth map corresponding to an area of interest set for the image, and an inverse converting unit configured to generate 3D shape data based on the depth map with a resolution of an area corresponding to the area of interest increased.

According to another aspect of the present invention, there is provided an information processing system, comprising: an information processing apparatus for processing three-dimensional (3D) information; a measurement apparatus configured to measure 3D shape data representing a shape of a 3D object; and an image capture apparatus configured to obtain data of an image of a field of view including the 3D object, wherein the information processing apparatus comprises: one or more processors that execute a program stored in a memory and thereby function as: a first obtaining unit configured to obtain 3D shape data representing a shape of a 3D object, a second obtaining unit configured to obtain data of an image of a field of view including the 3D object, a converting unit configured to generate a depth map corresponding to the field of view based on the 3D shape data, a resolution converting unit configured to increase a resolution of an area of the depth map corresponding to an area of interest set for the image, and an inverse converting unit configured to generate 3D shape data based on the depth map with a resolution of an area corresponding to the area of interest increased.

According to a further aspect of the present invention, there is provided an information processing method executed by an information processing apparatus, comprising: obtaining 3D shape data representing a shape of a three-dimensional (3D) object; obtaining data of an image of a field of view including the 3D object; generating a depth map corresponding to the field of view from the 3D shape data; increasing a resolution of an area of the depth map corresponding to an area of interest set for the image; and generating 3D shape data based on the depth map with a resolution of an area corresponding to the area of interest increased.

According to another aspect of the present invention, there is provided a non-transitory computer-readable medium that stores a program executable a computer, the program, when executed by a computer, causes the computer to function as an information processing apparatus comprising: a first obtaining unit configured to obtain 3D shape data representing a shape of a 3D object, a second obtaining unit configured to obtain data of an image of a field of view including the 3D object, a converting unit configured to generate a depth map corresponding to the field of view based on the 3D shape data, a resolution converting unit configured to increase a resolution of an area of the depth map corresponding to an area of interest set for the image, and an inverse converting unit configured to generate 3D shape data based on the depth map with a resolution of an area corresponding to the area of interest increased.

Further features of the present invention will become apparent from the following description of exemplary embodiments (with reference to the attached drawings).

### BRIEF DESCRIPTION OF THE DRAWINGS

FIG. 1 is a block diagram illustrating an example of the functional configuration of a 3D information processing system according to a first embodiment.

FIG. 2 is a flowchart relating to 3D shape data generation processing according to the first embodiment.

FIG. 3 is a schematic diagram relating to a process for 3D shape data generation processing according to the first embodiment.

FIGS. 4A and 4B are schematic diagrams relating to a process for 3D shape data generation processing according to the first embodiment.

FIG. 5 is a flowchart relating to area of interest setting processing according to the first embodiment.

FIG. 6 is a block diagram illustrating an example of the functional configuration of a 3D information processing system according to a second embodiment.

FIG. 7 is a flowchart relating to 3D shape data generation processing according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Note that in the embodiments described below, the present invention is implemented as a personal computer (PC). However, the present invention can be implemented as any electronic device that uses a microprocessor. Examples of such an electronic device include computer devices (tablet computers, media players, PDAs, and the like), smartphones, game consoles, robots, drones, drive recorders, and the like. These are examples, and the present invention can be implemented as other electronic devices.

### First Embodiment

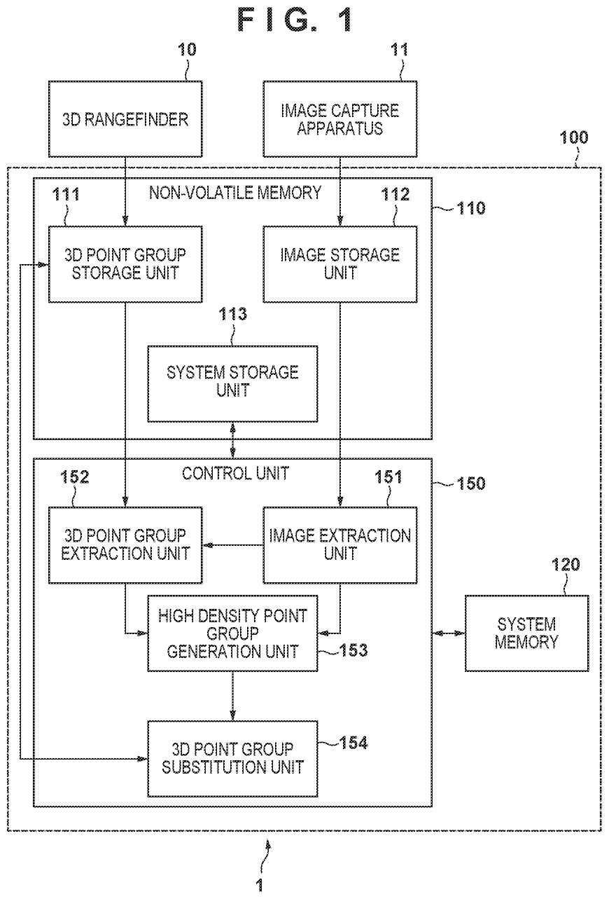

FIG. 1 is a block diagram illustrating an example of the functional configuration of an information processing system 1 according to the first embodiment of the present invention. The information processing system 1 includes an information processing apparatus 100, a rangefinder 10, and an image capture apparatus 11.

The information processing apparatus 100 includes a non-volatile memory 110, a system memory 120, and a control unit 150. The information processing apparatus 100 may be a personal computer, for example.

The rangefinder 10 measures data relating to the 3D shape of a target object. The rangefinder 10 is a LiDAR sensor that executes distance measurement based on time of flight of a light beam from when it is emitted to when the reflected light is detected while changing the emission direction of the light beam to generate a distance data group with a predetermined spatial resolution. The distance data can be converted into 3D coordinates on the basis of the emission direction of the light beam. The set (point group data) of 3D coordinates of the object surface represents the 3D shape of the object surface and thus can be treated as 3D shape data. Note that the distance may be measured using a phase difference between emitted light and reflected light.

In the present embodiment described herein, the 3D shape data is handled in the format of point group data, but the point group data may be converted to and handled as a different format such as a voxel, mesh, or implicit function format, for example.

Also, the rangefinder 10 is not limited to a configuration using a LiDAR sensor. For example, a configuration using a laser scanner, stereo vision, 3D reconstruction from moving images, or the like may be used.

The image capture apparatus 11 is a camera, for example, that outputs image data representing an image with the field of view that includes the distance measuring range of the rangefinder 10. The image capture apparatus 11 includes an image sensor that converts an optical image formed on an imaging plane by a lens unit into an analog image signal and an A/D converter that converts an analog image signal into a digital image signal (image data). Note that the image data output by the image capture apparatus 11 may be in a pre-color interpolation processing state (RAW format) or may be a post-color interpolation processing state.

The rangefinder 10 and the image capture apparatus 11 are communicatively connected via an interface included in the information processing apparatus 100. The operations of the rangefinder 10 and the image capture apparatus 11 are controlled by the control unit 150. The information processing apparatus 100 may include at least one of the rangefinder 10 and the image capture apparatus 11.

Note that position and orientation information of the rangefinder 10 and the image capture apparatus 11 and information (information relating to the lens unit focal length and optical axis direction) for specifying the field of view of the image capture apparatus 11 can be stored in the non-volatile memory 110 (system storage unit 113) in advance. Basically, the field of view and the image capture direction of the image capture apparatus 11 is set such that an area containing the distance measuring range of the rangefinder 10 is captured. Alternatively, the rangefinder 10 may be set such, for inside the field of view of the image capture apparatus 11, point group data is generated.

Note that the rangefinder 10 measures point group data with a predetermined first density (spatial resolution) with respect to the overall measurement range. In a case where a LiDAR sensor is used, for example, the density of the point group data is determined by the spatial resolution of the emission position of the light beam.

The non-volatile memory 110 is electrically rewritable. A 3D point group storage unit 111, an image storage unit 112, and the system storage unit 113 illustrating constituting the non-volatile memory 110 are a part of the memory space of the non-volatile memory 110.

The 3D point group storage unit 111 stores the point group data obtained from the rangefinder 10. The image storage unit 112 stores the image data obtained from the image capture apparatus 11.

The system storage unit 113 stores programs (OS, applications) executed by the control unit 150, various types of setting values, GUI data, and the like.

The system memory 120 is rewritable volatile memory such as DRAM. The system memory 120 temporarily stores programs executed by the control unit 150; constants, variables, and data read out from the non-volatile memory 110 used by programs being executed; and the like.

Note that in a case where the user interactively operates the information processing apparatus 100, the information processing system includes a display apparatus and a user interface connected to or built-in the information processing apparatus 100. The user interface device may be a keyboard, a mouse, a touchpad, or the like. Note that in a case where the display apparatus is a touch display, the touch display may also function as the user interface device.

The control unit 150 is a processor (CPU, MPU, microprocessor, or the like) that can execute programs, for example. By the control unit 150 loading a program stored in the system storage unit 113 into the system memory 120 and executing the program, the functions of the information processing apparatus 100, starting with the generation processing for 3D shape data described below, are implemented.

Note that an image extraction unit 151, a 3D point group extraction unit 152, a high density point group generation unit 153, and a 3D point group substitution unit 154 illustrated constituting the control unit 150 in the diagrams represent functions that are implemented by the control unit 150 executing a program. Accordingly, the operations executed by the image extraction unit 151, the 3D point group extraction unit 152, the high density point group generation unit 153, and the 3D point group substitution unit 154 are in practice executed by the control unit 150.

Note that of the functions implemented by the control unit 150 executing a program, for example, processing with a large calculation load may be implemented using a hardware circuit. Image processing and calculation processing relating to machine learning may be executed using a hardware circuit (GPU, NPU, or the like) suited to such processing.

The image extraction unit 151 extracts, from an image stored in the image storage unit 112, an area of interest on the basis of a feature amount of the image, for example. The image extraction unit 151 stores the data of the extracted area of interest in the image storage unit 112. The feature amount may be a feature amount for detecting an area of an object corresponding to a predetermined type. For example, the feature amount is stored associated with the type of the area of interest in the non-volatile memory 110, and the image extraction unit 151 can select the feature amount to use according to the settings, for example.

The 3D point group extraction unit 152 extract point group data included in the area of interest from the point group data stored in the 3D point group storage unit 111. The 3D point group extraction unit 152 can identify the point group data included in the area of interest using the position information of the rangefinder 10 and the image capture apparatus 11 stored in the system storage unit 113 and the image coordinates of the area of interest. The 3D point group extraction unit 152 stores the extracted point group data in the 3D point group storage unit 111.

Note that the 3D point group extraction unit 152 may identify the point group data included in the area of interest using a different method. For example, the point group data included in the area of interest may be identified on the basis of the feature amount used by the image extraction unit 151.

The high density point group generation unit 153 (resolution converting unit) generates point group data with a second density higher than the first density using a known method from the area of interest extracted by the image extraction unit 151 and the point group data with the first density extracted by the 3D point group extraction unit 152. The operations of the high density point group generation unit 153 will be described below in detail.

The 3D point group substitution unit 154 combines the point group data with the second density generated by the high density point group generation unit 153 with the point group data with the first density generated by the rangefinder 10. The combining may include substituting, of the point group data with the first density, the point group data included in the area of the point group data with the second density generated by the high density point group generation unit 153 with the point group data with the second density.

In this manner, in the present embodiment, of the point group data with the first density measured by the rangefinder 10, the density of the point group data inside a feature image area is increased to the second density. Accordingly, there is no need to obtain the point group data with the second density for the entire measuring area, and the point group data with the second density is obtained for the area of interest. In this manner, by using a configuration in which an area which requires point group data with a high density is extracted as an area of interest, an increase in the processing load and the data amount can be suppressed and the point group data can be efficiently generated.

The operations to generate the 3D shape data described above will be further described below.

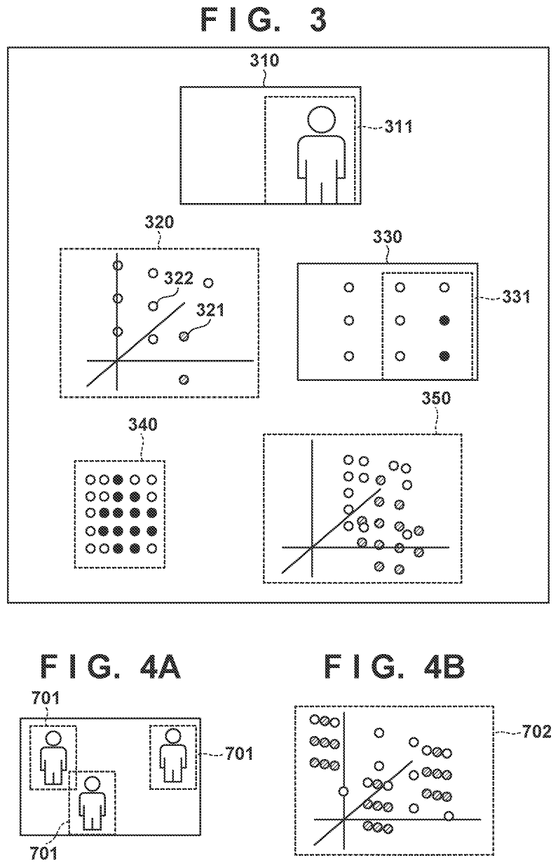

FIG. 3 is a diagram schematically illustrating a process for generating the 3D shape data according to the present embodiment. An original image 310 represents an original image obtained from the image capture apparatus 11, and an area of interest 311 represents an area of interest extracted from the original image 310 by the image extraction unit 151. Also, point group data 320 schematically represents the point group data in the field of view of the image capture apparatus 11 for the rangefinder 10. Two black dots 321 represent short-range distance information, and seven white dots 322 represent long-range distance information.

A depth image 330 is an image (depth map) of the point group data 320 projected in 2D space corresponding to the original image 310, and each pixel represents the distance in the image capture direction of the image capture apparatus 11. Note that for the sake of convenience, a “depth image” is represented here. However, the data forming the depth image 330 may in particular not be able to be viewed, and a data group with distance values or data corresponding to the distance values arranged corresponding to the original image 310 may be used. An area 331 represents an area corresponding to the area of interest 311 in the depth image. Also, a depth image 340 corresponds to the area 331 of the depth image 330 with the resolution (number of pixels) increased. A point group data 350 represents a state of the depth image 340 inverse projected in 3D space. By combining, of the point group data 320, the data not projected in the area 331 and the point group data 350, 3D shape data is obtained.

FIG. 4A illustrates a state in which a plurality of areas of interest 701 are set for the original image. In this case, the resolution of the depth image is increased for each area of interest. As a result, as illustrated in FIG. 4B, point group data 702 with the second density is generated for each area of interest.

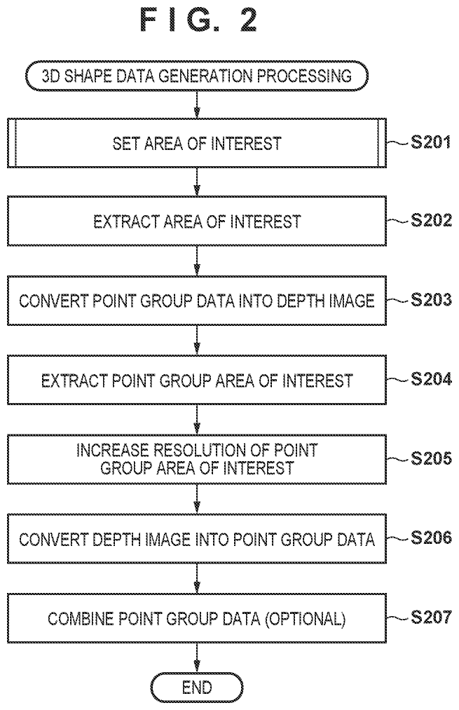

Using the flowchart in FIG. 2, the generation processing for 3D shape data will be further described. The processing illustrated in FIG. 2 is implemented by the control unit 150 executing a program such as a 3D shape data generation application program. Note that obtaining the point group data via the rangefinder 10 and obtaining the image data via the image capture apparatus 11 are not required to be executed at the time of 3D shape data generation, and data obtained in advance and stored in the non-volatile memory 110 may be used. Here, a case in which the original image 310 and the point group data 320 illustrated in FIG. 3 will be described.

In step S201, the image extraction unit 151 (first obtaining unit) obtains the data of the original image 310 stored in the image storage unit 112. Then, the image extraction unit 151 sets the area of interest in the original image 310. The area of interest can be a main subject area within the image for generating point group data with high density, such as the area of a person, for example. The details relating to setting the area of interest will be described below. Here, an area of a person as illustrated in FIG. 3 is set as the area of interest.

In step S202, the image extraction unit 151 extracts the data of the area of interest set in step S201 from the data of the original image 310 and stores this in the system memory 120. The image extraction unit 151, of the data of the original image 310 stored in the image storage unit 112, extracts the data of a rectangular area bounding the area of interest as the data of the area of interest, for example. Note that the data is not limited to a rectangular area bounding the area of interest, and data of an area defined by the contour of the area of interest may be extracted, data of a part of the area of interest may be extracted, or data of an area of a fixed size including the area of interest may be extracted. Also, an image may be displayed, and the extraction area may be decided by a user via the user interface device. In practice, no such limitation is intended. Here, the data of the area of interest 311 illustrated in FIG. 3 is extracted.

In step S203, the 3D point group extraction unit 152 (second obtaining unit), of the point group data 320 corresponding to the original image 310 stored in the 3D point group storage unit 111, the point group data 320 corresponding to the field of view of the original image 310 obtained in step S201 is obtained. Then, the 3D point group extraction unit 152 (converting unit) generates data of the depth image 330 corresponding to the original image 310 obtained in step S201. The 3D point group extraction unit 152 can generate data of the depth image 330 by projecting the extracted point group data on a plane perpendicular to the optical axis of the image capture apparatus 11 on the basis of the positional relationship between the rangefinder 10 and the image capture apparatus 11. The 3D point group extraction unit 152 stores the generated data of the depth image 330 in the system memory 120.

The depth image 330 may also be referred to as a depth map, and the values of each pixel forming the image represent the distance in the depth direction at the pixel position. The depth image 330 and the point group data 320 can be convert into one another. Note that the depth image 330 and the original image 310 have the same field of view, but the resolution (number of pixels) may be lower in the depth image 330 than in the original image 310. Note that in the present embodiment, the point group data 320 is converted into the depth image 330 using the position information of the rangefinder 10 and the image capture apparatus 11. However, the point group data 320 may be converted into the depth image 330 using another known method such as point group feature and image feature matching and a calibration method.

In step S204, the 3D point group extraction unit 152 extracts, of the data of the depth image 330 generated in step S203, the data of an area corresponding to the area of interest 311 extracted in step S202 as the data of the point group area of interest 331. The 3D point group extraction unit 152 stores the data of the point group area of interest 331 in the system memory 120.

In step S205, the high density point group generation unit 153 increases the density of the point group data included in the point group area of interest 331 using the data of the area of interest 311 extracted in step S202 and the data of the point group area of interest 331 extracted in step S204. This corresponds to increasing the number of pixels (upscaling) included in the point group area of interest 331, which is a partial area of the depth image 330, and generating the depth image 340. In this manner, the density of the point group data of the part of the original image 310 corresponding to the area of interest 311 can be increased.

For the method for increasing the density of the point group data using the corresponding 2D image data, a known method using a convolutional neural network (CNN) referred to as depth completion can be used. For details, refer to the following documents.
Xinjing Cheng et al., “Depth Estimation via Affinity Learned with Convolutional Spatial Propagation Network”, ECCV 2018, pp. 108-125, Sep. 8, 2018
Jinsun Park, et al., “Non-Local Spatial Propagation Network for Depth Completion”, ECCV 2020, pp. 120-136, Jul. 20, 2020

In this manner, the high density point group generation unit 153 can increase the density of the point group data using a CNN trained using a known technique such as that described in these documents, for example. The high density point group generation unit 153 stores the generated depth image 340 in the system memory 120.

In step S206, the high density point group generation unit 153 (inverse converting unit) converts (inverse projection) the combined depth image obtained by combining the depth image 330 and the depth image 340 into point group data. This conversion can be executed via an inverse conversion of the conversion executed by the 3D point group extraction unit 152 in step S203. In this manner, point group data of the entire original image 310 with the point group data of the area of interest 311 part having high density is obtained. This corresponds to point group data obtained by combining the point group data 350 and the point group data 320 in FIG. 3.

Note that instead of converting the combined depth image into point group data, in step S206, only the depth image 340 may be converted into the point group data 350, and in step S207, the point group data 350 may be combined with the point group data 320 by the 3D point group substitution unit 154.

### Area of Interest Setting Processing

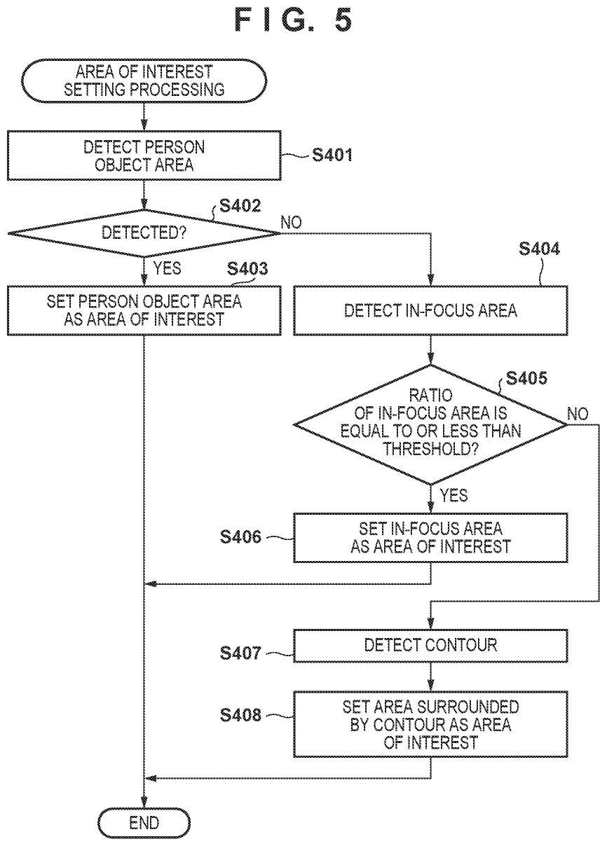

The area of interest setting processing of step S201 will now be described in detail using the flowchart of FIG. 5. Here, an example in which an area of a person object is set as a specific object will be described. However, the type of object set as the area of interest is not limited to a person. For example, in a case where a shooting mode for shooting an object of a specific type is set at the time of shooting the original image 310, an area of the object of a type according to the settings at the time of shooting may be set as the area of interest. Also, the user may set the type of object. Furthermore, the area of interest may be set according to a condition other than the type of object, for example, the object area including the focus detection area at the time of shooting or an area including a specific color may be set as the area of interest.

In step S401, the image extraction unit 151 applies person object area detection processing on the original image 310. A person object area can be detected using any known method such as a method including template matching or a method using a trained neural network. In a case where two or more person object areas are detected, the image extraction unit 151 selects one or more of the areas on the basis of a predetermined condition, such as the area with a detected position closest to the center of the image or the largest area.

In step S402, the image extraction unit 151 determines whether or not a person object area has been detected in step S401 and, if a person object area has been detected, executes step S403 and, if a person object area has not been detected, executes step S404.

In step S403, the image extraction unit 151 sets the person object area selected in step S401 as the area of interest and ends the processing.

In step S404, the image extraction unit 151 detects in-focus area(s) in the original image 310. Note that the in-focus area can be detected using a known method, such as applying wavelet transformation to the original image 310. Note that in a case where the information relating to the position of the focus detection area at the time of shooting is known such as being stored in a data file of the original image 310, the in-focus area may be detected on the basis of the position of the focus detection area.

In step S405, the image extraction unit 151 obtains the ratio of the in-focus area detected in step S404 to the entire original image 310 and determines whether or not the ratio is equal to or less than a predetermined threshold. Then, if the image extraction unit 151 determines that the ratio is equal to or less than the threshold, step S406 is executed, and if the image extraction unit 151 determines that the ratio is not equal to or less than the threshold, step S407 is executed.

In step S406, the image extraction unit 151 sets the in-focus area detected in step S404 as the area of interest and ends the processing.

In step S407, the image extraction unit 151 applies contour detection processing to the data of the original image 310. Contour detection processing can be executed using any known method such as a magnitude determination using a histogram of oriented gradients feature amount, for example.

In step S408, the image extraction unit 151 sets the area surrounded by the contour detected in step S407 as the area of interest and ends the processing.

Note that here, either the person object area, the in-focus area, or the area surrounded by the detected contour is set as the area of interest. However, the area of interest may be set from among the person object area, the in-focus area, and the area surrounded by the contour. Also, the feature area may be set using a combination of conditions such as setting the area with the highest focus degree from among the person object areas as the area of interest.

In the present embodiment, of the point group data measured with the first density or resolution, the point group data included in the area of interest is increased in density to the second density higher than the first density to generate more detailed 3D shape data for the area of interest compared to the other areas. Thus, there is no need to measure the point group data at a high density from the start. Also, the density of the point group data can be increased without measuring, and thus there is no need to use a sensor large in size and cost that can measure at high density. Furthermore, the volume of point group data obtained via measuring can be suppressed.

On the other hand, detailed point group data can be obtained for the area of interest. Accordingly, by setting an area requiring detailed shape data as the area of interest, useful 3D shape data can be generated efficiently while suppressing the processing load.

### Second Embodiment

Next, the second embodiment of the present invention will be described. The present embodiment is different from the first embodiment in that a plurality of areas of interest are set. The differences from the first embodiment will be focused on in the description below. In the present embodiment, after an area of interest is set, an image with high resolution of the area of interest is obtained and used when increasing the density of the point group data.

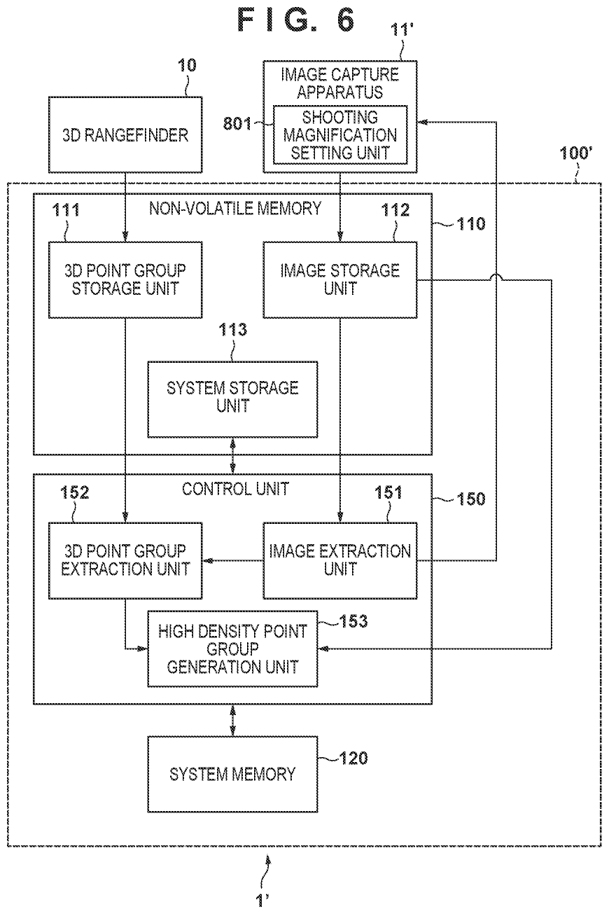

FIG. 6 is a block diagram illustrating an example of the functional configuration of an information processing system 1′ according to the second embodiment. The information processing system 1′ includes an information processing apparatus 100′, the rangefinder 10, and an image capture apparatus 11′. Configurations shared with the first embodiment are given the same reference number, and redundant descriptions will be skipped. Note that though not illustrated in FIG. 6, the information processing apparatus 100′ may include the 3D point group substitution unit 154 as in the first embodiment.

The image capture apparatus 11′ includes a shooting magnification setting unit 801. The shooting magnification setting unit 801 is a zoom lens, for example. The field of view (focal length) of the zoom lens can be controlled by control unit 150. Image capture is performed by the image capture apparatus 11 after the magnification at the time of shooting is set on the basis of a setting value via control or hardware. Note that in a case where an image with high resolution for an area of interest is obtained regardless of image capture, the image capture apparatus 11′ may not include the shooting magnification setting unit 801.

Here, the original image is shot at a first magnification. Note that the first magnification is less than the maximum magnification able to be set for the image capture apparatus 11′.

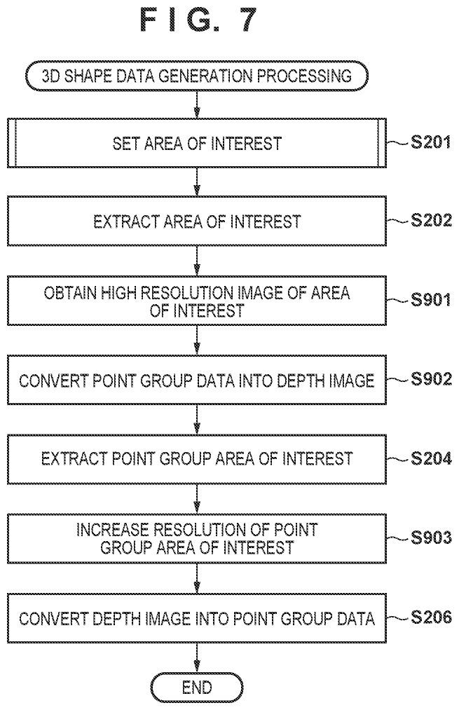

FIG. 7 is a flowchart relating to the 3D shape data generation processing according to the present embodiment. Processes in FIG. 7 that execute the same processing as in the first embodiment are given the same reference number as in FIG. 2 and the description is skipped.

In step S901, the control unit 150 obtains an image with higher resolution than the original image for the area of interest set by the image extraction unit 151 in step S202. The control unit 150 controls the shooting magnification setting unit 801 (for example, a zoom lens) of the image capture apparatus 11′ to execute shooting at a second magnification higher than when shooting the original image. Then, by trimming the area of interest from the image data stored in the image storage unit 112, the control unit 150 can obtain an image with a higher resolution than the original image for the area of interest. Note that the control unit 150 can control the shooting magnification setting unit 801 such that the area of interest can be shot at the maximum magnification able to be achieved in an area not greater than the field of view without changing the optical axis direction of the image capture apparatus 11′, for example. Accordingly, the magnification of the area of interest at the time of re-shooting may be different depending on the size and position of the area of interest.

Alternatively, by increasing the resolution of the original image using known image processing, the control unit 150 may obtain an image with a higher resolution than the original image for the area of interest. In this case, shooting using the image capture apparatus 11′ is unnecessary. Also, for magnification, there are not limitations such as the time of shooting. In a case where data of an area of interest with resolution increased using image processing is generated, the control unit 150 stores the generated image data in the system memory 120.

In step S902, the 3D point group extraction unit 152 converts the point group data corresponding to the original image stored in the 3D point group storage unit 111 into a depth image as in step S203. Note that the point group data corresponding to the field of view at the time of re-shooting in step S901 may be converted into a depth image. The 3D point group extraction unit 152 stores the generated data of the depth image in the system memory 120.

In step S903, the high density point group generation unit 153 increases the density of the point group data included in the point group area of interest using the data of the area of interest with the second magnification (high resolution) obtained in step S901 and the point group area of interest extracted in step S204. The image of the area of interest obtained in step S901 has higher resolution (higher number of pixels) than the area of interest of the original image. Thus, the accuracy of the point group data obtained via increasing the density can be better than when using the data of the area of interest of the original image.

As described above, in the present embodiment, the resolution of an area of interest is increased above the resolution of an area of interest in the original image using high density processing of point group data. Accordingly, in addition to the effects of the first embodiment, the accuracy of the point group data obtained on the basis of a depth image with high resolution can be increased.

### Other Embodiments

The embodiments described above may be combined in part or fully as long as no contradictions arise.

Also, increasing the density of the point group data (increasing the resolution of the depth image) can be executed using any technique for increasing the resolution of an image.

Also, the area of interest may be set without using information of the image obtained by the image capture apparatus 11. For example, this may be set on the basis of information other than the feature amount of an image such as using shape information obtained by an ultrasonic wave sensor, temperature information obtained by a temperature sensor, a combination thereof, and the like. Also, the area of interest may be set using both information other than the feature amount of an image and the feature amount of an image.

Note that the operations described as being executed by the control unit 150 may be executed by a single piece of hardware or may be executed via the cooperation of a plurality of pieces of hardware (for example, a plurality of processors and circuits).

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-208800, filed on Dec. 26, 2022, which is hereby incorporated by reference herein in its entirety.

What is claimed is:

1. An information processing apparatus for processing three-dimensional (3D) information, comprising:
one or more processors that execute a program stored in a memory and thereby function as:
a first obtaining unit configured to obtain 3D shape data representing a shape of a 3D object,
a second obtaining unit configured to obtain data of an image of a field of view including the 3D object,
a converting unit configured to generate a depth map corresponding to the field of view based on the 3D shape data,
a resolution converting unit configured to increase a resolution of an area of the depth map corresponding to an area of interest set for the image, and
an inverse converting unit configured to generate 3D shape data based on the depth map with a resolution of an area corresponding to the area of interest increased.

2. The information processing apparatus according to claim 1, wherein the inverse converting unit generates 3D shape data based on data of an area of the depth map with the resolution increased, and
the one or more processors further function as a combining unit configured to combine 3D shape data obtained by the first obtaining unit and 3D shape data generated by the inverse converting unit.

3. The information processing apparatus according to claim 1, wherein the resolution converting unit uses data of the area of interest when increasing the resolution.

4. The information processing apparatus according to claim 3, wherein a resolution of the area of interest used when increasing the resolution is higher than a resolution of the area of interest in an image obtained by the second obtaining unit.

5. The information processing apparatus according to claim 4, wherein the information processing apparatus obtains data of the area of interest used when increasing the resolution by making an image capture apparatus shoot an image containing the area of interest at a shooting magnification higher than a shooting magnification of an image obtained by the second obtaining unit.

6. The information processing apparatus according to claim 4, wherein the information processing apparatus obtains data of the area of interest used when increasing the resolution by increasing a resolution of the area of interest of an image obtained by the second obtaining unit using image processing.

7. The information processing apparatus according to claim 1, wherein the one or more processors further function as a setting unit configured to set the area of interest, and
wherein the setting unit sets an area of a specific object included in the image as the area of interest.

8. The information processing apparatus according to claim 7, wherein in a case where an area of the specific object is not detected in the image, the setting unit sets an in-focus area of the image or an area surround by a contour as the area of interest.

9. The information processing apparatus according to claim 1, wherein the 3D shape data is point group data.

10. An information processing system, comprising:
an information processing apparatus for processing three-dimensional (3D) information;
a measurement apparatus configured to measure 3D shape data representing a shape of a 3D object; and
an image capture apparatus configured to obtain data of an image of a field of view including the 3D object,
wherein the information processing apparatus comprises:
one or more processors that execute a program stored in a memory and thereby function as:
a first obtaining unit configured to obtain 3D shape data representing a shape of a 3D object,
a second obtaining unit configured to obtain data of an image of a field of view including the 3D object,
a converting unit configured to generate a depth map corresponding to the field of view based on the 3D shape data,
a resolution converting unit configured to increase a resolution of an area of the depth map corresponding to an area of interest set for the image, and
an inverse converting unit configured to generate 3D shape data based on the depth map with a resolution of an area corresponding to the area of interest increased.

11. An information processing method executed by an information processing apparatus, comprising:
obtaining 3D shape data representing a shape of a three-dimensional (3D) object;
obtaining data of an image of a field of view including the 3D object;
generating a depth map corresponding to the field of view from the 3D shape data;
increasing a resolution of an area of the depth map corresponding to an area of interest set for the image; and
generating 3D shape data based on the depth map with a resolution of an area corresponding to the area of interest increased.

12. A non-transitory computer-readable medium that stores a program executable a computer, the program, when executed by a computer, causes the computer to function as an information processing apparatus comprising:
a first obtaining unit configured to obtain 3D shape data representing a shape of a 3D object,
a second obtaining unit configured to obtain data of an image of a field of view including the 3D object,
a converting unit configured to generate a depth map corresponding to the field of view based on the 3D shape data,
a resolution converting unit configured to increase a resolution of an area of the depth map corresponding to an area of interest set for the image, and
an inverse converting unit configured to generate 3D shape data based on the depth map with a resolution of an area corresponding to the area of interest increased.
